(19) United States
(12) Patent Application Publication
(10) Pub. No.: US 2008/0040129 A1
(43) Pub. Date: Feb. 14, 2008

(54) Systems and methods for providing a vehicle service management service

(75) Inventors: Mark Cauwels, Grapevine, TX (US); Alexander Keechle, Irving, TX (US); Shannon Allmon, Dallas, TX (US); Ryan Bell, Addison, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/500,404

(22) Filed: Aug. 8, 2006

(51) Int. Cl. G06Q 10/00; G06Q 30/00

(52) U.S. Cl. 705/1

(57) ABSTRACT

Embodiments consistent with the invention relate to providing incentives related to product services. In one embodiment, a computer-implemented method for providing an incentive related to a vehicle maintenance service is provided. The method may include receiving a registration request from a customer. The registration request may include a vehicle identification number of a vehicle associated with the customer. Further, the method may include determining a maintenance reminder trigger for a maintenance service for the vehicle based on the registration request and vehicle data stored in a database and sending a maintenance reminder for the maintenance service to the customer. Additionally, a request for offers may be received from the customer to a plurality of vendors that are configured to provide the maintenance service. Also, a bid may be received from each vendor for providing the maintenance service, and provided to the customer. The method also includes receiving a selection of at least one of the bids by the customer.

### TECHNICAL FIELD

The present invention generally relates to computer-implemented systems and methods for providing a product service management service. Moreover, the invention relates to systems and methods for providing incentives, such as lower interest rates, to customers obtaining scheduled services at preferred vendors.

### BACKGROUND

Recently, financial institutions are becoming increasingly competitive. This is beneficial to customers because a competitive marketplace drives down prices as financial institutions, such as commercial banks, mortgage bankers, credit card issuers, and other lenders, attempt to increase their market share by offering better financial products or incentives than their competitors.

For example, a financial institution may offer low interest credit cards or loans to motivate potential customers to transfer their credit card or loan balances from other financial institutions. The same is true for offers or incentives on other types of financial products, such as mortgages, automobile loans, or any other type of customer loan.

In addition, other incentives have been implemented, such as reward programs that provide points, cash-back payments, or other rewards based on purchases made by a customer or credit cardholder. Such programs are generally seen as an effective way to maintain customers and reduce attrition to competitors.

In a similar manner, financial institutions have established relationships with merchants or vendors to provide incentives to their customers. For example, banks and credit card issuers may offer special points or rewards to their customers for purchases made with particular merchants or vendors. In some cases, special offers may be presented to customers, such as the ability to purchase products or services at a discount from a merchant or vendor. These offers may be presented in various formats, such as in a mailed flyer or monthly billing statement. Customers may then evaluate these offers and decide on whether to purchase the product or service at the specific price presented in the offer.

While effective for providing customer services, several drawbacks exist with these conventional methods. For example, rewards cards provide points or incentives to participating customers, but many times require a customer to make considerable purchases before the benefits of such rewards can be realized. In other words, customers often need to spend a considerable amount of money on purchases in order to obtain a sufficient quantity of points or awards. Many times, customers will not redeem their points or otherwise lose interest in the incentives and, thus, never fully realize the benefits.

Another problem that exists is that many merchants provide matching deals or promotions, whereby one merchant agrees to match an offer provided by another merchant to a potential customer. For example, credit cardholders that receive offers to purchase products or services at discounted prices may take these offers to other merchants to obtain the same product or service at a discounted price. In these cases, the financial institution providing the incentive may lose referral fees. Additionally, or alternatively, the costs associated with offering the discounted products or services may need to be absorbed by the financial institution.

In addition, financial institutions have had difficulties in providing incentives or forging relationships with merchants in specific markets, such as the automotive service market. Customers of a financial institution, who own an automobile or have purchased an automobile from the financial institution, often may have to have maintenance services performed on their vehicle or have a maintenance check performed at predetermined times during the life of the vehicle. For example, automobiles require periodic and/or non-periodic service. As a result, customers of automobiles schedule service for their automobiles at selected merchant locations. However, it has been difficult for financial institutions, such as credit card issuers, to offer traditional incentives, including reward points to encourage customers to schedule service with particular merchants. This leads to missed partnering opportunities, as well as lost referral fees.

In view of the foregoing, a need exists for improved systems and methods for providing financial product incentives to attract or retain customers that can be applied to a wide array of market segments. Such incentives should not require customers to make a high level or number of purchases to qualify or to receive the full benefit of a promoted incentive or reward.

### SUMMARY

Accordingly, embodiments consistent with the present invention relate to systems and methods that may alleviate one or more of the above-described limitations or disadvantages of conventional financial product incentive mechanisms.

Embodiments consistent with one or more aspects of the present invention are associated with product service/maintenance, such as an automotive service. Further, the disclosed embodiments provide incentives to customers to obtain service/maintenance of products at preferred or partnered vendors.

In accordance with one embodiment, a computer-implemented method is provided. As disclosed herein, the method may be implemented for providing a vehicle maintenance service. The method may comprise receiving a registration request from a customer, wherein the registration request includes a vehicle identification number of a vehicle associated with the customer. The method may also include determining a maintenance reminder trigger for a maintenance service for the vehicle based on the registration request and vehicle data stored in a database and sending a maintenance reminder for the maintenance service to the customer. A request for offers received from the customer may be sent to a plurality of vendors that are configured to provide the maintenance service. The method also includes receiving, from each vendor, a bid for providing the maintenance service, providing the vendor bids to the customer, and receiving a selection of at least one of the bids by the customer.

Embodiments consistent with the invention also relate to a computer-implemented system for providing a vehicle maintenance service. The system may comprise a component configured to receive a registration request from a customer, wherein the registration request includes a vehicle identification number of a vehicle associated with the customer. The system may also include a component configured to determine a maintenance reminder trigger for a maintenance service for the vehicle based on the registration request and vehicle data stored in a database and a component configured to send a maintenance reminder for the maintenance service to the customer. Further, the system includes a component configured to send a request for offers received from the customer to a plurality of vendors that are configured to provide the maintenance service. Moreover, the system includes a component configured to receive, from each vendor, a bid for providing the maintenance service, a component configured to provide the vendor bids to the customer, and a component configured to receive a selection of at least one of the bids by the customer.

Embodiments consistent with another aspect of the invention further relate to computer program products including instructions for execution by a processor to perform methods for providing a vehicle maintenance service. The method may comprise receiving a registration request from a customer, wherein the registration request includes a vehicle identification number of a vehicle associated with the customer. The method may also include determining a maintenance reminder trigger for a maintenance service for the vehicle based on the registration request and vehicle data stored in a database and sending a maintenance reminder for the maintenance service to the customer. A request for offers received from the customer may be sent to a plurality of vendors that are configured to provide the maintenance service. The method also includes receiving, from each vendor, a bid for providing the maintenance service, providing the vendor bids to the customer, and receiving a selection of at least one of the bids by the customer.

It is to be understood that both the foregoing general description and the following detailed description are exemplary and explanatory only, and should not be considered restrictive of the scope of the disclosed invention. Additional features and/or variations may be provided. For example, embodiments of the invention may be directed to one or more combinations and/or sub-combinations of the features described in the detailed description.

### BRIEF DESCRIPTION OF THE DRAWINGS

The accompanying drawings, which are incorporated in and constitute a part of this specification, illustrate one or more embodiments consistent with certain aspects of the invention and together with the description, serve to explain one or more principles of the invention. In the drawings:

FIG. 1 illustrates an exemplary system environment for implementing embodiments consistent with certain aspects of the present invention;

FIG. 2 illustrates a block diagram related to an exemplary maintenance service system consistent with certain embodiments of the present invention;

FIG. 3 illustrates a block diagram related to an exemplary maintenance service database consistent with certain embodiments of the present invention; and

FIG. 4 is a flowchart of an exemplary process for providing an offer for maintenance service for a vehicle, consistent with certain embodiments of the present invention.

### DETAILED DESCRIPTION OF THE EMBODIMENTS

Reference will now be made in detail to exemplary embodiments consistent with the invention, examples of which are illustrated in the accompanying drawings. Wherever possible, the same reference numbers will be used throughout the drawings to refer to the same or like parts.

The following detailed description refers to the accompanying drawings. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering or, adding steps to the disclosed methods. Accordingly, the following detailed description does not limit the invention.

Embodiments consistent with the present invention are directed to systems, methods, and computer-readable media for providing one or more incentives to one or more customers to have maintenance service performed on their vehicles at selected merchant locations. Embodiments consistent with the invention may be implemented using different computers and in different type of environments, including computer-based environments using computer devices, such as personal computers, workstations, servers, laptops, personal digital assistants (PDAs), mobile phones, handheld devices and other types of computing devices.

By way of example, embodiments consistent with the invention may be implemented using conventional personal computers (PCs), desktops, hand-held devices, multiprocessor computers, pen computers, microprocessor-based or programmable customer electronics devices, minicomputers, mainframe computers, personal mobile computing devices, mobile phones, portable or stationary personal computers, palmtop computers or the like.

The storage media referred to herein may include components that temporarily or permanently store data and/or instructions. For example, storage media may include a read-only memory (ROM), a random access memory (RAM), etc. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM), or a digital versatile disk (DVD); and (c) semiconductor media (e.g., DRAM, SRAM, EPROM, EEPROM, memory stick).

Embodiments consistent with the invention may also include computer program products that are stored in a computer-readable medium or transmitted using a carrier, such as an electronic carrier signal communicated across a network between computers or other devices. In addition to transmitting carrier signals, one or more network environments may be provided to link or connect components implemented by the disclosed embodiments, such as, enterprise-wide computer networks, intranets and the Internet (i.e., the World Wide Web). These network environments may include a wired or a wireless network, including a local area network (LAN), a wide area network (WAN), a public switched telephone network (PSTN), an Integrated Services Digital Network (ISDN), an infrared (IR) link, a radio link, such as a Universal Mobile Telecommunications System (UMTS), Global System for Mobile Communication (GSM), Code Division Multiple Access (CDMA), and/or a satellite link.

The disclosed embodiments may implement any type of transmission protocol and data format, such as, for example, Transmission Control Protocol/Internet Protocol (TCP/IP), Hyper Text Transfer Protocol (HTTP), secure HTTP, wireless application protocol, Unique Resource Locator (URL), Unique Resource Identifier (URI), Hyper Text Markup Language (HTML), eXtensible Markup Language (XML), extensible Hyper Text Markup Language (XHTML), Wireless Application Markup language (WML), and Standard Generalized Markup Language (SGML), etc.

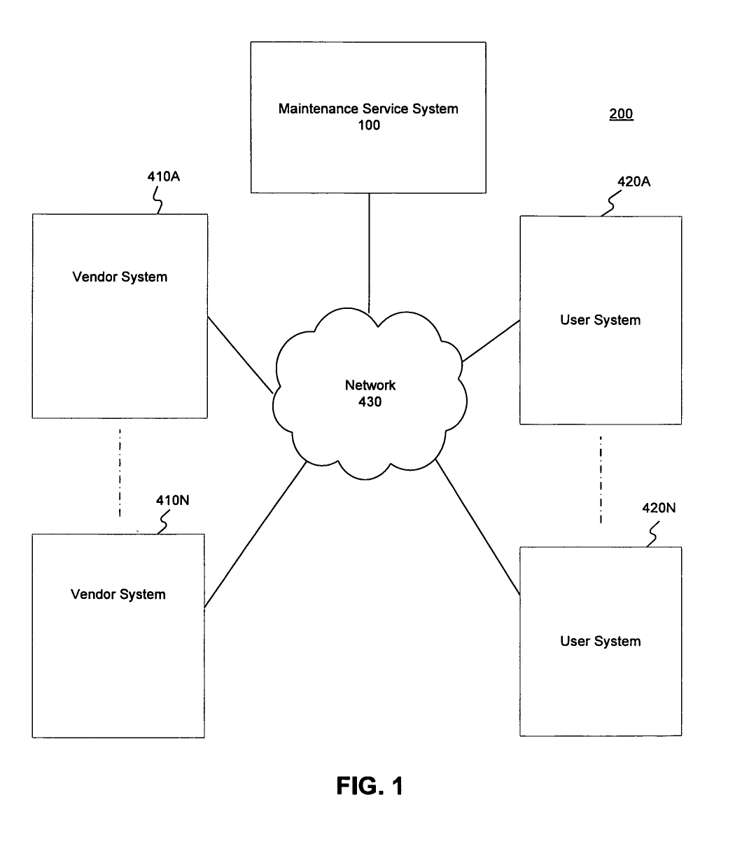

Systems, methods, and computer-readable media consistent with certain embodiments of the present invention provide an incentive to a customer to have maintenance service performed on a product purchased, owned or otherwise associated with the customer. More specifically, systems, methods, and computer readable media consistent with the present invention provide the customer offers or bids from one or more selected vendors offering maintenance service for a product associated with the customer. Further, embodiments of the present invention provide the customer an incentive to have the maintenance service performed at selected vendors. For exemplary purposes only, details of the embodiments related to FIGS. 1-4 are related to a maintenance service for a vehicle, such as an automobile, truck, van, motorcycle and the like. One of ordinary skill in the art, however, will appreciate that embodiments of the invention may be implemented for any type of product and, thus, are not limited to vehicles or maintenance service of vehicles.

FIG. 1 illustrates an exemplary system environment 200 for implementing one or more embodiments of the present invention. As shown in FIG. 1, system 200 may comprise one or more computer systems, such as one or more vendor systems 410A-410N, one or more user systems 420A-420N (implemented as “clients”) and a maintenance service system 100 (implemented as a “server”). The components of environment 200 may be connected and communicate with one another through a network 430, which may include any type of communication network (e.g., Internet, LANs, PSTN, etc.).

Vendor systems 410A-410N may each reflect systems associated with business entities providing services consistent with principles of the present invention. Vendor systems 410A-410N may each be implemented with a computing system combined to perform one or more tasks consistent with certain embodiments of the present invention. Vendor systems 410A-410N may be located in different geographical locations and may each be managed and/or controlled by a business entity providing services. In this example, vendor systems 410A-410N provide one or more maintenance services for vehicles. In a preferred embodiment, each vendor system 410A-410N is located at a particular vendor providing such services.

User systems 420A-420N may each reflect a system used by a customer to access certain embodiments consistent with the present invention. User systems 420A-420N may each comprise a computing system configured to perform one or more tasks consistent with certain embodiments of the present invention. In one embodiment, each user system 420A-420N may include a network interface configured to enable a customer to interact with maintenance service system 100. User systems 420A-420N may each be located in any location, such as a customer's home, office, kiosk or terminal located at a vendor, etc. Additionally, one skilled in the art will appreciate that any number of user systems 420A-420N may be provided to enable access to maintenance service system 100 by one or more customers of a business entity, such as a financial institution (e.g., bank, credit card issuer, lender, etc.).

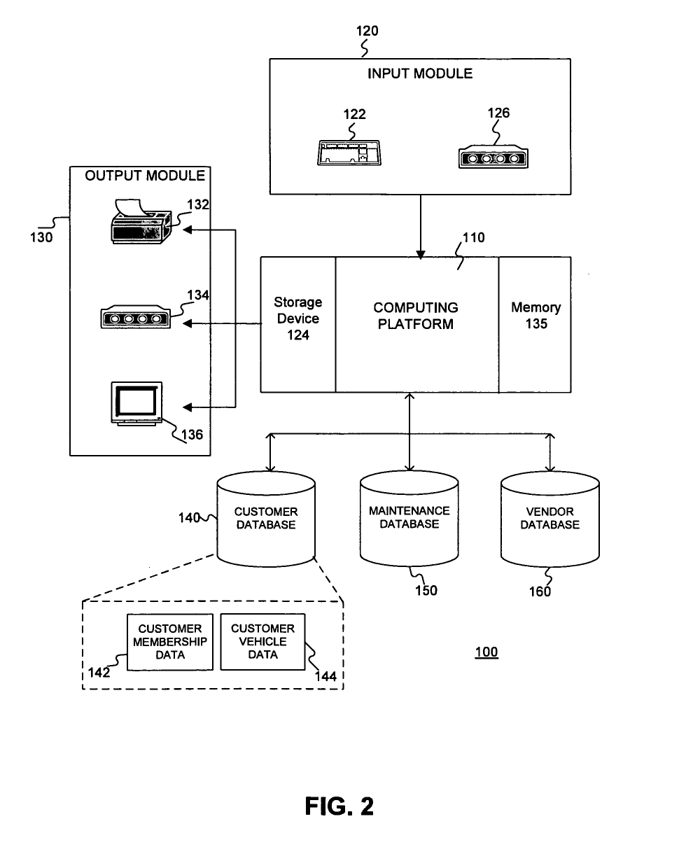

FIG. 2 illustrates a block diagram of an exemplary maintenance service system 100 consistent with certain embodiments of the present invention. As explained, maintenance service system 100 may be configured to provide a mechanism for customers of one or more financial institutions to obtain vehicle service from one or more vendors. As such, the financial institution(s) may have formed partnerships or other relationships with one or more vendors to provide incentive rewards to their customers for using these vendor(s) to perform vehicle services.

As illustrated in FIG. 2, maintenance service system 100 may include a computing platform 110, an input module 120, a storage device 124, an output module 130, a memory 135, a customer database 140, a maintenance database 150, and a vendor database 160. Computing platform 110 may be a computer system that is adapted to process information received from input module 120. Computing platform 110 may further be adapted to provide output information to output module 130. Additionally, computing platform 110 may access and process information stored in customer database 140, maintenance database 150, and/or vendor database 160 to perform one or more processes consistent with certain embodiments of the present invention.

In one embodiment, computing platform 110 may comprise a general purpose computer (e.g., a personal computer, network computer, server, or mainframe computer) having a processor that may be selectively activated or reconfigured by a computer program to perform one or more methods consistent with the present invention. Computing platform 110 may also be implemented in a distributed network. Alternatively, computing platform 110 may be specially constructed for performing one or more methods consistent with certain embodiments of the present invention.

Input module 120 may be a device for receiving information from a user or computer system. Input module 120 may include an input device 122 and/or a network interface 126. Input device 122 may be implemented using a keyboard, mouse, speech recognition device, wireless device, PDA, mobile phone, handheld device and/or other type of data entering device. Network interface 126 may be an interface configured to receive information over any type of network (not shown), such as a telephony-based network (e.g., PBX or POTS), a local area network, a wide area network, a dedicated intranet, and/or the Internet. Computing platform 110 may also access data stored on storage device 124. Storage device 124 may include a memory, such as RAM or ROM memory, that contains instructions or data for performing one or more methods consistent with the present invention.

Input module 120 may be used by a user to enter or obtain registration information associated with a customer and/or vendor, maintenance records and schedules associated with a vehicle associated (e.g., purchased or owned) with the customer, requests by the customer to obtain maintenance service for the vehicle, and one or more bids from one or more vendors who may provide the maintenance service. This information and requests may be obtained, for example, from an employee, from storage device 124, and/or from another computing system via network interface 126. Computing platform 110 may store the information received from input module 120 in customer database 140, maintenance database 150, and/or vendor database 160.

As further described below, computing platform 110 may use the stored customer, maintenance, and/or vendor information to provide an incentive reward to the customer for having a maintenance service performed at a selected vendor. Computing platform 110 may also provide notifications to output module 130 related to reminders, bids, and/or maintenance service information for interested parties, such as the customer.

Output module 130 may be a device for providing information to interested parties. Output module 130 may include a printer 132, an output interface 134, and/or a display 136. Printer 132 may be used to provide a printout to interested parties of relevant information, such as maintenance service information associated with a vehicle, bids for performing service on the vehicle, confirmation of a special incentive reward, etc. Output interface 134 may be used to provide such relevant information and/or other information to the interested parties via the Internet, email, fax, page, etc. or save the information on a computer-readable medium. Display 136 may be a display device configured to display the reminders, bids, and/or other information to interested parties.

Customer database 140 may be a database system that stores customer membership data 142 and customer vehicle data 144. Customer membership data 142 preferably includes a record of personal data associated with customers, such as name, address, telephone number, driver's license number, social security number, credit card account number, checking account number, etc. Customer membership data 142 may also include the customer's membership identification (“ID”) and password. Customer vehicle data 144 preferably includes a record of vehicles and characteristics of the vehicles associated with the customer. For example, customer vehicle data 144 could contain information with regards to previous vehicles the customer has owned or had provided to computing platform 110. Characteristics of vehicles may include make, model, year, etc. Customer database 140 may also include one or more credit histories and/or credit ratings associated with the customers.

Maintenance database 150 may preferably include a record of maintenance service data associated with one or more vehicles, such as the maintenance service history, maintenance schedule, proposed maintenance service, location of prior servicing, odometer readings, vehicle purchase date, identification numbers associated with the vehicles, vehicle ownership at time of service, etc. In one embodiment, maintenance database 150 may include one or more records associated with vehicle dealers within a dealership or a manufacturer's network or from one or more vendors that provide vehicle maintenance service, and/or consumers who have performed maintenance service on vehicles. In one aspect, a business entity related to maintenance service system 100 may establish a contract with one or more vendors for receipt of the maintenance service data. Maintenance service data could be received via an automated mechanism, such as receipt of files containing the maintenance service data from the vendors. Alternatively, or in addition to, maintenance service data may be received from the use of online mechanisms, such as having vendors enter maintenance service data (for service performed on a vehicle) in web pages that directly populate maintenance database 150. A skilled artisan would appreciate that many other alternatives could be implemented in embodiments consistent with the present invention. To enable standardized receipt of data from the vendors, maintenance service system 100 may provide a standard format for receiving maintenance data. For example, an XML record may be used by maintenance service system 100, such as:

```
<?xml version=”1.0”?
<Maintenance>
  <Vehicle>
  <VIN=”123” </VIN>
  <manufacturer=”Honda” </manufacturer>
  <type=“Accord” </type>
  <year=”1995” </year>
  <date=”05/31/2006” </date>
  <service=”oil change” </service>
  <vendor=”Jiffy Lube” <.vendor>
  <odometer=”0000019” </odometer>
  <zip=”77475” </zip>
  </Vehicle>
</Maintenance>
```

As another example, the following XML record could be used by maintenance service system 100:

```
<?xml version=”1.0”?
<Maintenance>
  <vendor id>“283913649”</vendor id>
  <vendor>”Jiffy Lube”</vendor>
  <zip>”77475”</zip>
  <maintenance date>”05/31/2006”</maintenance date>
  <customer name>”John Q. Customer”</customer name>
  <customer address>”169 Sycamore Road, Philadelphia,
  PA 76924”</customer address>
    <Vehicle>
      <VIN>”1FTDR11T5GTA01050”</VIN>
      <manufacturer>”Honda”</manufacturer>
      <model>“Accord”</model>
      <year>”2003”</year>
      <odometer>”0035319”</odometer>
      <license state>”TX”</license state>
      <license tag>”643HYU”</license tag>
        <Service>
          <service type>“preventative”</service type>
          <service description>”oil change”</service description>
        </Service>
        <Service>
          <service type>“preventative”</service type>
          <service description>”radiator flush”</service description>
        </Service>
        <Service>
          <service type>“repair”</service type>
          <service description>”radio antenna fix”</service description>
        </Service>
        <Service>
          <service type>“inspection”</service type>
          <service description>”annual inspection -
          pass”</service description>
        </Service>
    </Vehicle>
</Maintenance>
```

After maintenance service data is obtained and stored in maintenance database 150, computing platform 110 may perform processing and provide access to the maintenance service data. For example, computing platform 110 may review and analyze the maintenance service data and provide reminders to customers that their vehicles are scheduled for service (discussed below). Alternatively, or in addition to, computing platform 110 may provide access, for example, to customers or other parties who desire to review the maintenance history of a particular vehicle. Access to the maintenance service data may be driven by any key identifier, such as vehicle identifier numbers (“VINs”) associated with the vehicles, customer IDs, etc.

Maintenance database 150 may also store financial information that is used for marketing or sales purposes. For example, computing platform 110 may collect transaction data using conventional methods from the use of financial products, such as credit cards and store the transaction data in maintenance database 150. For instance, computing platform 110 may collect data related to products purchased, location of the purchases, etc. from use of financial products provided by a business entity maintaining maintenance system 100 and store the data in maintenance database 150. In one embodiment, the business entity can provide computing platform 110 transaction data associated with customers entered into maintenance database 150. Then, computing platform 110 may analyze the received transaction data and store any relevant data into maintenance database 150. For example, computing platform 110 may analyze the standard industry codes (“SIC”) in the received transaction data to determine which products/services the customers have purchased and store any data that is desired. For instance, computing platform 110 may analyze the received transaction data to locate SIC 7549 (as an example) to locate all automotive transactions (except repair and carwashes) and determine the customer and location of the automotive service and store that data in maintenance database 150.

Further, computing platform 110 may provide access to the collected transaction data for analysis purposes. For example, a user and/or processor may use the transaction data to determine consumer purchase behavior, purchasing trends, recent consumer purchases, etc. Results of the analysis may be provided to interested parties, such as dealers, vendors, etc. For instance, a user and/or processor can analyze the transaction data to determine that the last time a customer obtained automotive service on a vehicle associated with the customer, the vehicle had an odometer reading of 90,000 miles. The user and/or processor may then provide such analysis to a dealer in order to provide an opportunity to the dealer to target the customer for the purchase of a new vehicle. As another example, the user and/or processor can analyze the transaction data to determine which customers are within a certain proximity of a particular vendor and are associated with vehicles that may need service and the user and/or processor can provide this information to the vendor.

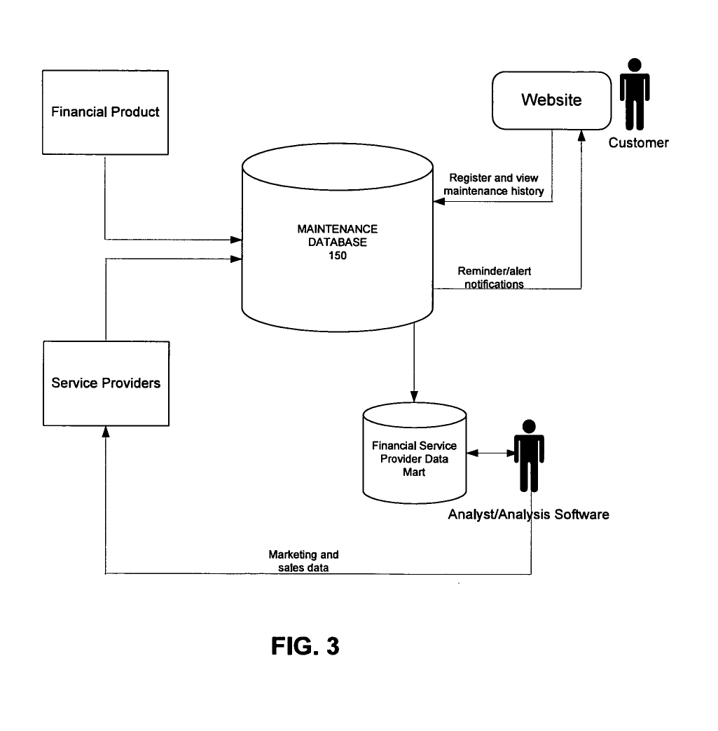

FIG. 3 shows a block diagram related to maintenance service data consistent with certain embodiments of the present invention. As shown in FIG. 3, maintenance service data from one or more vendors, such as vehicle dealers and service providers, is collected and stored in maintenance database 150. As explained, maintenance service data may be configured and received in a standard format. As also shown in FIG. 3, a customer may receive reminders and alerts based on the data stored in maintenance database 150 and also may register and view the maintenance history of a specific vehicle. Moreover, as shown in FIG. 3, transaction data related to a use of a financial product (e.g., credit card, financial account, etc.) may be collected and stored in maintenance database 150. The financial data may be provided to an analyst (e.g., user and/or software executed by a processor). The analyst may perform analysis of data to provide, for example, marketing and sales information to interested parties, such as one or more dealers of vehicles or service providers.

Vendor database 160 may be a database system that includes preferably a record of one or more vendors participating in an incentive program or other arrangement with the financial institution(s). In one embodiment, vendor database 160 may include data related to geographical directions to a vendor, the services provided by the vendors, agreements between the vendors and a financial institution, records related to customers with visits to the vendors to receive maintenance service, ratings for the vendors based on customer feedback surveys, records of fees received from the vendors, sale projections for the vendors, profit margins for the vendors, membership identifiers associated with the vendors, passwords associated with the vendors, etc.

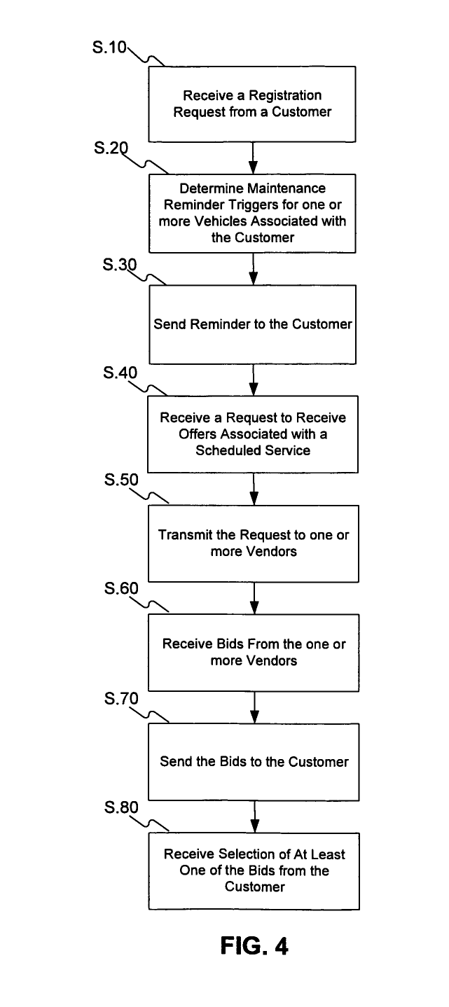

FIG. 4 illustrates a flowchart of an exemplary process for providing an incentive related to maintenance service for a vehicle associated with a customer, consistent with certain aspects related to the present invention. Although the steps of the process are described as being performed in a particular order, one skilled in the art will appreciate that these steps may be performed in a modified or different order, or in an embodiment involving fewer than the steps described below. Further, one or more of the steps disclosed in FIG. 4 may be performed concurrently or in parallel.

Initially, computing platform 110 may receive a registration request from a customer (Step S.10). The registration request may include the name, address, phone number, financial account number, etc. associated with the customer. The registration request may also identify any vehicles that may need maintenance service that are associated with the customer. The customer may identify the vehicles using a unique global identifier, such as a VIN. The registration request may also specify a location associated with the customer or desired locale in which to receive service on the customer's vehicle. The registration request can be submitted in response to an offer provided to the customer. For instance, a financial institution may provide an offer to the customer to enroll in a vehicle maintenance service program. In response to the offer, the customer may enroll in the program and thus be assigned a customer membership ID and/or password that is stored in customer database 140. After enrolling, the customer may provide the personal and/or vehicle information.

In a preferred embodiment, the customer submits the registration request via a web page and the request is transmitted to computing platform 110 over the Internet. The web page may be a dedicated web page for a maintenance service program or other service program provided by the financial institution. In one aspect, only members of these programs may submit requests using special log-in information. The customer may provide information regarding the registration request using any known web-based input mechanisms provided by web pages, such as pull-down menus, text boxes, selection boxes, hyperlinks, and the like.

Once registered, the customer may be offered one or more financial or product based incentives, services, etc. by computing platform 110. In one aspect, computing platform 110 may generate one or more reminder triggers for a vehicle associated with the customer (Step S.20). A reminder trigger is a reminder relating maintenance service that may need to be performed on the vehicle. Based on the identification number associated with the vehicle, computing platform 110 determines a maintenance schedule and maintenance history for the vehicle from data included in maintenance database 150. Based on the maintenance schedule and history, computing platform 110 may determine maintenance service that may need to be performed on the vehicle and prepares a reminder message to be sent to the customer. For example, computing platform 110 may determine that, it has been over three months or 3,000 miles since the last oil change for a vehicle owned by the customer. As a result, computing platform 110 prepares a reminder for the customer regarding the scheduled oil change. As another example, computing platform 110 may determine that it has been over two years or 24,000 miles since the last change in transmission fluid for the vehicle owned by the customer and, thus, prepares a reminder for the customer regarding the scheduled change in transmission fluid. Computing platform 110 then sends the reminder to the customer (Step S.30). Computing platform 110 may send the reminder to the customer using any communication medium, such as telephone, email, fax, page, text message, etc.

The customer may review the reminder and determine whether to have the scheduled service performed. If the customer decides to have the service performed, the customer may request computing platform 110 to provide offers for the scheduled service. Accordingly, computing platform 110 receives a request to receive offers associated with a vehicle's scheduled service (Step S. 40). After receiving the request to receive offers, computing platform 110 electronically transmits the request for offers along with vehicle information and scheduled service information to one or more vendor systems 410A-410N managed by a respective vendor who is capable of providing the scheduled service (Step S.50). To do so, computing platform 110 may access customer database 140 to obtain identification and contact data associated with the customer. Computing platform 110 may also access vendor database 150 to identify one or more vendors that may provide the maintenance service. For instance, computing platform 110 may access vendor database 150 to identify one or more vendors that are located in a determined proximity to the customer. The request for offers may be sent to those vendors. A skilled artisan would appreciate that computing platform 110 may use any criteria in selecting vendors that may perform maintenance service. For example cost of service, etc.

Additionally, the customer may also include one or more preferences in the request to receive offers. As a result, computing platform 110 may identify one or more applicable vendors to send the request for performing the service(s). For instance, the customer may identify in the request a preferred locale to deliver their vehicle for service. Further, the customer may identify additional services they may prefer, such as a loaner car, etc. Alternatively, or in addition to, the customer may identify preferred ratings for vendors. Computing platform 110 may analyze the data in vendor database 150 to identify one or more vendors that match the customer's preferences. In another embodiment, the request to receive offers may include a price that the customer is willing to pay for the scheduled service. Computing platform 110 may provide the request to each vendor identified who then decides whether to provide a bid based on the requested price (discussed below). In an alternate embodiment, the process may skip Steps S.30 and S.40 and automatically transmit a request for offers along with vehicle information and scheduled service information to vendor system 410.

Computing platform 110 may then receive one or more offers (“bids”) from the vendors willing to provide the schedule service (Step S.60). The bids may include an estimate for the scheduled service and other services or incentives the vendor is willing to provide. For example, a bid from a vendor may include an estimate to perform an oil change and a list of services, such as tire rotation, car wash, loaner vehicle, etc. that may be provided free of charge or at a discount price. The bids may also include contracts to provide vehicle maintenance service. For example, the bids may include an annual contract to provide an oil change and tire rotation at a predetermined price. As another example, the bids may include a lifetime contract to provide brake service at a predetermined price. In the configuration where the request for offers includes a price, the vendors may evaluate the price and determine if they wish to provide the scheduled service at the customer's requested price. If so, the vendor may provide an appropriate bid.

Once the bids are received, computing platform 110 may send the bids to user systems 420A-420N controlled by the customer (Step S.70). Computing platform 110 may also provide additional information, such as customer feedback or survey data associated with the vendors providing the bids. Computing platform 110 may also include information on the location of the vendors providing the bids (e.g., directions to the vendor, etc.), time constraints associated with the bids, etc. Computing platform 110 may further include additional offers to encourage the customer to proceed with the scheduled service (discussed below) using one or more of the selected vendors.

Computing platform 110 may provide the bids and other information to the customer in any desired format. For example, computing platform 110 may sort the bids based on any criteria or suggest a recommended bid. Computing platform 110 may then receive a bid selection from the customer (Step S.80). The customer may select a bid from the bids provided by computing platform 110 using user systems 420A-420N and in response, the selection is sent to computing platform 110. Using user systems 420A-420N, the customer may be able to view and sort the bids by one or more criteria selected by the customer prior to making a selection.

Once a bid is selected, an appointment can be scheduled with the corresponding vendor. In one embodiment, computing platform 110 may automatically schedule the service appointment after receiving the selection from the customer. Alternatively, the customer may schedule an appointment with the vendor. In one embodiment, the customer may be provided multiple options and/or time slots for scheduling an appointment with the vendor. Based on this information, the customer may select a desired option and/or time slot. After obtaining the scheduled service, the customer may provide feedback information via a survey to computing platform 110. The survey may be provided to the customer electronically (e.g., e-mail, Web site, etc.), paper-based (e.g., mail surveys), and/or personal based (e.g., telephonic or in-person surveys). Based on the customer's response to the survey, and possibly other customer responses, computing platform 110 may update the vendor ratings.

In an alternate embodiment, the process may skip Steps S.70 and S.80 and automatically select at least one of the received bids which the customer must accept. For instance, if the request for offers included a customer requested price and a vendor is willing to provide the schedule service at that price, then the customer may be required to accept the bid. To this end, computing platform 110 may execute code that automatically identifies and selects a bid for a customer based on the price requested by the customer. A skilled artisan would appreciate that many other configurations are possible. For example, computing platform 110 may conduct a conventional auction for bids received from the dealers and/or maintenance service providers. The auctions may be conducted using on-line electronic mechanisms. For example, silent real-time auctions, public real-time auctions, sealed-bid auctions, or Dutch auctions, etc. may be conducted.

Further, in another configuration, incentives may be provided to customers to encourage the customers to proceed with a scheduled service at one or more preferred vendors. As discussed above, if a customer obtains a scheduled service at a vendor that is not partnered or preferred by the financial institution, then potential referral fees may be lost. Therefore, a financial institution may provide different types of incentives to customers to encourage them to obtain the scheduled service at a preferred or partnered vendor that have provided a bid for a requested service. For example, if a customer is an auto loan customer, the financial institution may lower the interest percentage rate, monthly payments, balance, etc. to reward the customer for obtaining the scheduled service at one or more preferred or partnered vendors. To verify that a customer obtained the scheduled service at a preferred vendor, the customer may send, via fax, email, mail, etc, a copy of documentation that confirms that the scheduled service was performed by the preferred or partnered vendor. Alternatively, the preferred or partnered vendor may send the documentation to the financial institution or provide any other method of confirmation, such as placing a phone call. One skilled in the art would appreciate that any other kind of incentive may be provided to the customers to encourage obtaining scheduled services at preferred or partnered vendors. For instance, the financial institution may provide reward points, cash back, traveler miles, rebates, discounts, coupons, etc., or any type of benefit associated with a financial account related to the customer as an incentive to the customers choosing a preferred or partnered vendor.

As discussed above, vendor database 160 may store a record of agreements between one or more financial institutions and various vendors. The agreements may identify a predetermined fee that the vendor may provide to the financial institution for each customer referred to the vendor by the financial institution via aspects related to the present invention. For example, the agreement between the financial institution and the vendor may indicate that the vendor will provide a monetary fee or percentage fee (e.g., $150 or 10% of the service price) for each customer referred to the vendor by the financial institution. Alternatively, or in addition to, the agreement may identify a monthly fee, yearly fee, etc. that the vendor may provide to the financial institution. A skilled artisan will appreciate that different types of referral fees or compensation may be implemented by embodiments consistent with the present invention. Also, each customer may be required to pay a fee to the financial institution for receiving bid services related to the disclosed embodiments. The referral fee may be determined or updated based on different factors that may affect pricing determinations, such as number of referrals, cost of referrals, profit margins, length of relationships, sales forecasts, time of year, location, sales goals, etc.

For example, in one embodiment, a pricing model may be developed over time by analyzing and testing the results of various combinations and permutations involving the factors discussed above. For example, data regarding the above-mentioned factors stored in vendor database 160 may be collected from vendors that have been found to provide profitable relationships for the financial institution, and using multivariate regression analysis, predictive pricing models can be developed to enable the prediction of the best referral fees for any future agreements with vendors or re-evaluation of past agreements. For instance, after a multivariate regression model identifies the most predictive factors for determining profitability of vendors, it can create a profitability model formula including only the identified factors. The formula may weigh each identified factor to minimize the error in generating a predictive profitiability score for vendors. For example, the multivariate logistic regression model may, by using regression techniques well known in the art, weigh the most predictive of the identified factors more heavily than the least predictive of the identified factors.

Also, the weights may account for differences in the types of data analyzed. For example, the formula may allow for simultaneous entry of percentages, probabilities, numbers, and/or dollar amounts. A small number, such as a probability (ranging from 0-1) may be weighed more heavily than a large number, such as revenue, to account for the different data types. Although the multivariate logistic regression model described herein initially determines the weights, one skilled in the art can appreciate that the weights may be modified later to comply with experimental results or other personal experience, for example.

After generating the formula, computing platform 110 may create a profitability grid using the historical vendor data. To accomplish this, computing platform 110 may use the determined weighted combination of factors to determine the profitability score for each vendor in the historical vendor data. Computing platform 110 then may generate a profitability grid by dividing these profitability score determinations into a predetermined number of groups. For example, the determined profitability scores may be divided into five groups, each group receiving a group score ranging from a score of 1 (low) to 5 (high). In a preferred embodiment, computing platform 110 can determine the range of profitability scores for each group according to the percentage of vendors that fall within that range. For example, the range of determined profitability scores containing the highest 20% of the determined profitability scores receives a group score of five (5). The range containing the next highest 20% of the profitability score determinations receives a group score of four (4), etc. One skilled in the art can recognize that other scoring methods are possible. The formula and profitability grid may then be used to determine the referral fee for a particular vendor. More particularly, computing platform 110 may enter the identified factors associated with a vendor into the formula to determine the profitability score of the vendor. Computing platform 110 then may use the profitability grid to determine a group score (e.g., 1-5) for the vendor based on the determined profitability score.

The computing platform 110 then can make a determination about the referral fee based on the score. For instance, for a vendor found to have a group score of five (5) and considered to provide a profitable relationship to the financial institution, computing platform 110 may determine that a low referral fee can be established. On the other hand, if the vendor has a lower group score, such as four (4), then computing platform 110 may determine that a higher referral fee may be required.

A skilled artisan would appreciate that the exemplary pricing model can also be used similarly to determine any other parameters or configurations desired by the financial institution. For instance, the pricing model may be used to predict the most effective configuration for incentives that may be provided to customers or for determining the most effective configuration for fees that customers may need to pay in embodiments consistent with the present invention.

Embodiments consistent with the principles of the present invention facilitate the servicing of products, such as vehicles for customers. Further, the embodiments provide incentives to these customers to obtain the servicing of the products at preferred or partnered vendors. Other embodiments of the invention will be apparent to those skilled in the art from consideration of the specification and practice of the invention disclosed herein. It is intended, therefore, that the specification and examples be considered as exemplary only, with a true scope and spirit of the invention being indicated by the following claims.

What is claimed is:

1. A computer-implemented method for providing an incentive related to a vehicle maintenance service, comprising:
receiving a registration request from a customer, wherein the registration request includes a vehicle identification number of a vehicle associated with the customer;
determining a maintenance reminder trigger for a maintenance service for the vehicle based on the registration request and vehicle data stored in a database;
sending a maintenance reminder for the maintenance service to the customer;
sending a request for offers received from the customer to a plurality of vendors that are configured to provide the maintenance service;
receiving, from each vendor, a bid for providing the maintenance service;
providing the vendor bids to the customer; and
receiving a selection of at least one of the bids by the customer.

2. The method of claim 1, wherein the vehicle data stored in the database is collected from a set of vendors in a standardized format.

3. The method of claim 1, further comprising providing an incentive to the customer to encourage the customer to obtain the maintenance service from at least one of the vendors providing the bids.

4. The method of claim 3, wherein the incentive is in the form of a lower interest rate for a financial loan for the customer.

5. The method of claim 3, wherein the incentive is in the form of at least one of a discount, rebate, and reward points.

6. The method of claim 1, wherein the registration request is received by a financial institution that provides a financial account to the customer related to the vehicle.

7. The method of claim 6, wherein the plurality of vendors and the financial institution have an established business relationship.

8. The method of claim 1, wherein the request for offers includes customer preferences including at least one of a location and additional preferred services and the request for offers are sent only to vendors matching the customer preferences.

9. The method of claim 1, wherein the request for offers includes a price and at least one of the received bids is automatically selected based on a comparison with the price.

10. A computer-implemented system for providing an incentive related to a vehicle maintenance service, comprising:
a component configured to receive a registration request from a customer, wherein the registration request includes a vehicle identification number of a vehicle associated with the customer;
a component configured to determine a maintenance reminder trigger for a maintenance service for the vehicle based on the registration request and vehicle data stored in a database;
a component configured to send a maintenance reminder for the maintenance service to the customer;
a component configured to send a request for offers received from the customer to a plurality of vendors that are configured to provide the maintenance service;
a component configured to receive, from each vendor, a bid for providing the maintenance service;
a component configured to provide the vendor bids to the customer; and
a component configured to receive a selection of at least one of the bids by the customer.

11. The system of claim 10, wherein the vehicle data stored in the database is collected from a set of vendors in a standardized format.

12. The system of claim 10, further comprising a component configured to provide an incentive to the customer to encourage the customer to obtain the maintenance service from at least one of the vendors providing the bids.

13. The system of claim 12, wherein the incentive is in the form of a lower interest rate for a financial loan for the customer.

14. The system of claim 12, wherein the incentive is in the form of at least one of a discount, rebate, and reward points.

15. The system of claim 10, wherein the registration request is received by a financial institution that provides a financial account to the customer related to the vehicle.

16. The system of claim 15, wherein the plurality of vendors and the financial institution have an established business relationship.

17. The system of claim 10, wherein the request for offers includes customer preferences including at least one of a location and additional preferred services and the request for offers are sent only to vendors matching the customer preferences.

18. The system of claim 10, wherein the request for offers includes a price and at least one of the received bids is automatically selected based on a comparison with the price.

19. A computer program product including instructions for execution by a processor to perform a method for providing an incentive related to a vehicle maintenance service, the method comprising:
receiving a registration request from a customer, wherein the registration request includes a vehicle identification number of a vehicle associated with the customer;
determining a maintenance reminder trigger for a maintenance service for the vehicle based on the registration request and vehicle data stored in a database;
sending a maintenance reminder for the maintenance service to the customer;
sending a request for offers received from the customer to a plurality of vendors that are configured to provide the maintenance service;
receiving, from each vendor, a bid for providing the maintenance service;
providing the vendor bids to the customer; and
receiving a selection of at least one of the bids by the customer.

20. The computer program product of claim 19, wherein the method further comprises providing an incentive to the customer to encourage the customer to obtain the maintenance service from at least one of the vendors providing the bids.
